(19) United States
(12) Patent Application Publication
(10) Pub. No.: US 2024/0014025 A1
(43) Pub. Date: Jan. 11, 2024

(54) CYCLE TIMER FOR IMPROVED PURITY OF REAGENT GAS SYSTEMS

(71) Applicant: Thermo Finnigan LLC, San Jose, CA (US)

(72) Inventor: Edward B. McCAULEY, Cedar Park, TX (US)

(21) Appl. No.: 18/335,929

(22) Filed: Jun. 15, 2023

Related U.S. Application Data
(60) Provisional application No. 63/359,343, filed on Jul. 8, 2022.

(51) Int. Cl. H01J 49/14

(52) U.S. Cl. CPC H01J 49/145

(57) ABSTRACT

A system including a gas source coupled to a mass spectrometer with a supply line to provide reagent gas for chemical ionization; a bypass line connecting the supply line to a foreline of a vacuum pump, the bypass line including a valve and a bypass restrictor; and a cycle timer operable to open the valve for a first period of time and close the valve for a second period of time.

### CROSS-REFERENCE TO RELATED APPLICATIONS

This application claims the priority of U.S. Provisional Application Ser. 63/359,343 filed on Jul. 8, 2022, the disclosure of which is incorporated herein by reference in its entirety.

### FIELD

The present disclosure generally relates to the field of mass spectrometry including a cycle timer for improved purity of reagent gas systems.

### INTRODUCTION

Mass spectrometry can be used to perform detailed analyses on samples. Chemical ionization (CI) is a well-known mass spectrometry analytical technique. Devices and methods employing chemical ionization typically deliver low flows of ammonia, methane, isobutane or other gas of ultra-high purity into a closed ionization volume of a mass spectrometer.

Chemical ionization is a proton transfer process. Consequently, water vapor must be kept to an absolute minimum in order to prevent undesirable competing ion-molecule reactions from occurring. This is of particular importance for ion trap mass analyzers or ion storage devices due to the prolonged residence time of gas phase ions. Unfortunately, water vapor is ubiquitous and easily adsorbs to the internal surfaces of gas lines, pressure regulators, flow controllers and various components comprising the analytical system.

Permanent gas impurities such as nitrogen and oxygen are easily purged from the pneumatics and gas lines and present no challenge, since large flows can be employed for final purging prior to connection of gas lines. Water, on the other hand, is a “sticky” molecule which results in the need to purge pneumatic devices for many hours or even several days before an equilibrium is established due to the low flows employed for CI (approximately 1 mL/min). Once equilibrium is established, stopping the gas flow for several hours may result in a disturbance of the established equilibrium, and introduce a variable in the amount of gas-phase water vapor present when CI is again used.

Localization of the reagent gas supply as well as the use of small-bore short length tubing is a prudent practice. Once a system is “dry”, it is highly un-desirable to open the plumbing in any way which might re-introduce water vapor into the system. This includes changing gas cylinders.

CI is often an “intermittent use” technique. It can be used in conjunction with electron ionization (EI) for confirmation of molecular ion for example. As such, CI may be employed occasionally such as once per several days when such studies or confirmations are undertaken. As such, there is a need for improved gas supply systems for CI.

### DRAWINGS

For a more complete understanding of the principles disclosed herein, and the advantages thereof, reference is now made to the following descriptions taken in conjunction with the accompanying drawings and exhibits, in which:

FIG. 1 is a block diagram of an exemplary mass spectrometry system, in accordance with various embodiments.

FIG. 2 is a diagram illustrating an exemplary CI gas supply, in accordance with various embodiments.

FIG. 3 is an exemplary method of periodically purging the CI gas supply line, in accordance with various embodiments.

FIG. 4 is a block diagram illustrating an exemplary computer system.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DESCRIPTION OF VARIOUS EMBODIMENTS

Embodiments of systems and methods for maintaining reagent gas purity are described herein and in the accompanying exhibits.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

### Mass Spectrometry Platforms

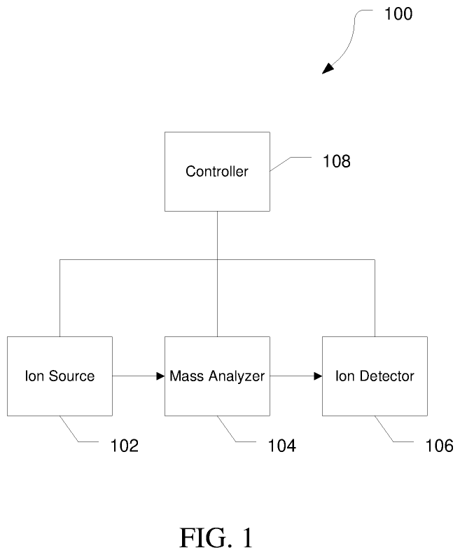

Various embodiments of mass spectrometry platform 100 can include components as displayed in the block diagram of FIG. 1. In various embodiments, elements of FIG. 1 can be incorporated into mass spectrometry platform 100. According to various embodiments, mass spectrometer 100 can include an ion source 102, a mass analyzer 104, an ion detector 106, and a controller 108.

In various embodiments, the ion source 102 generates a plurality of ions from a sample. The ion source can include, but is not limited to, a matrix assisted laser desorption/ionization (MALDI) source, electrospray ionization (ESI) source, atmospheric pressure chemical ionization (APCI) source, atmospheric pressure photoionization source (APPI), inductively coupled plasma (ICP) source, electron ionization source, chemical ionization source, photoionization source, glow discharge ionization source, thermospray ionization source, and the like.

In various embodiments, the mass analyzer 104 can separate ions based on a mass to charge ratio of the ions. For example, the mass analyzer 104 can include a quadrupole mass filter analyzer, a quadrupole ion trap analyzer, a time-of-flight (TOF) analyzer, an electrostatic trap (e.g., ORBITRAP) mass analyzer, Fourier transform ion cyclotron resonance (FT-ICR) mass analyzer, and the like. In various embodiments, the mass analyzer 104 can also be configured to fragment the ions using collision induced dissociation (CID) electron transfer dissociation (ETD), electron capture dissociation (ECD), photo induced dissociation (PID), surface induced dissociation (SID), and the like, and further separate the fragmented ions based on the mass-to-charge ratio.

In various embodiments, the ion detector 106 can detect ions. For example, the ion detector 106 can include an electron multiplier, a Faraday cup, and the like. Ions leaving the mass analyzer can be detected by the ion detector. In various embodiments, the ion detector can be quantitative, such that an accurate count of the ions can be determined.

In various embodiments, the controller 108 can communicate with the ion source 102, the mass analyzer 104, and the ion detector 106. For example, the controller 108 can configure the ion source or enable/disable the ion source. Additionally, the controller 108 can configure the mass analyzer 104 to select a particular mass range to detect. Further, the controller 108 can adjust the sensitivity of the ion detector 106, such as by adjusting the gain. Additionally, the controller 108 can adjust the polarity of the ion detector 106 based on the polarity of the ions being detected. For example, the ion detector 106 can be configured to detect positive ions or be configured to detected negative ions.

### CI Gas Supply System

Water tends to adsorb onto surfaces such as the interior of gas supply lines, regulators, couplings, and the like. Unlike other more volatile contaminants, water is slow to desorb from these surfaces and can continue to be a source of contamination to an ultra-pure gas flow for a long period of time, especially at low flow rates used for CI reagent gas. As the water vapor can interfere with the CI, it is preferable to minimize the water contamination in the flow of reagent gas. One way to ensure low levels of water contamination in the gas flow is to continually flow gas through the supply line. However, CI is often used intermittently as a confirmation to EI mass spectrometry. Thus, a continuous flow of gas would significantly increase the gas usage and increase the frequency at which the gas source would need to be replaced. Significantly, replacing the gas source introduces water to the system and would require an extended period to flush the newly introduced water and restore the equilibrium.

As an alternative to a continual flow of gas, disclosed herein are systems and methods to periodically flush the supply line to minimize water contamination while reducing the amount of wasted reagent gas. As a result, CI mass spectrometry data is improved while reducing the amount of wasted reagent gas.

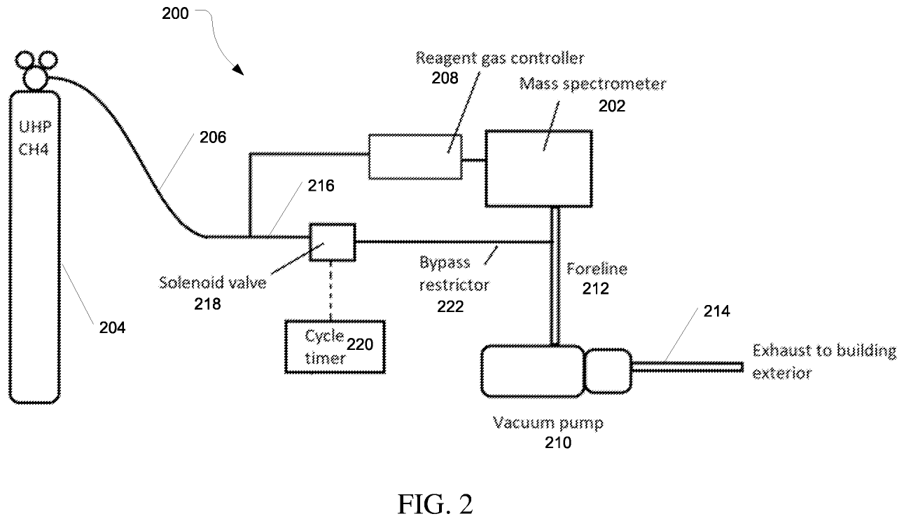

FIG. 2 illustrates a system 200 for providing CI gas to a mass spectrometer 202. A gas source 204, such as a gas cylinder can provide high purity gas. A supply line 206 can direct the gas from the gas cylinder to a reagent gas controller 208. The reagent gas controller can control the flow of reagent gas into the mass spectrometer 202 when utilizing CI. The gas controller can shut off the reagent gas flow into the mass spectrometer when utilizing EI.

Mass spectrometer 202 can be connected to a vacuum pump 210 through a foreline 212. The vacuum pump 210 can remove gases from the mass spectrometer 202, maintain the mass spectrometer 202 under vacuum during operation. The vacuum pump 210 can direct waste gases from the mass spectrometer 202 to an exhaust line 214.

A bypass line 216 can be connected to the supply line 206. Preferably, the bypass line 216 would connect close to the reagent gas controller to minimize the length of supply line 206 that is downstream of the bypass line 216 connection. A solenoid valve 218 can be coupled to the supply line 216 to shut off or allow gas flow through the supply line 216. A cycle timer 220 can control the solenoid valve 218. A bypass restrictor 222 can couple the solenoid valve 218 to the foreline 212. The bypass restrictor 222 can be sized to limit the flow of gas to the vacuum pump 210 to prevent exceeding a critical pressure of foreline 212 necessary to maintain the high vacuum of mass spectrometer 202.

The cycle timer 220 can cause the solenoid valve 218 to be open for a first set period of time (open time) and closed for a second set period of time (closed time). During the open time, gas from the gas source 204 can flow through the supply line 206, through the bypass line 216 to the foreline 212 of the vacuum pump 210. The vacuum pump 210 can direct the gas to the exhaust line 214. The open time can have a sufficient duration to purge the supply line 206. In various embodiments, the open time can be a function of the flow rate through the bypass line 216 to the foreline 212, the length of the supply line 206, the inner diameter of the supply line 206, or any combination thereof.

In various embodiments, the cycle timer 220 can be coupled to controller 108 of FIG. 1. The controller can adjust the cycle timer 220, such as based on usage of the mass spectrometer and other factors. For example, the cycle timer 220 could be instructed to leave the solenoid valve closed when the mass spectrometer is frequently collecting CI data. In other embodiments, the controller 108 can control the solenoid valve directly, flushing the supply line prior to any CI mass spectrometer data collection.

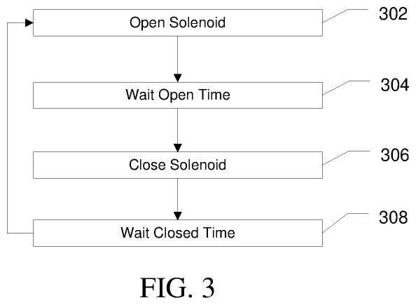

FIG. 3 illustrates a method of periodically purging a gas supply line. At 302, a cycle timer can open a solenoid valve to allow gas to flow through a supply line to a bypass line and to a vacuum pump. At 304, the solenoid can remain open for a first set period of time (open time) to purge the supply line. At 306, the cycle timer can close the solenoid valve, shutting off the flow of gas through the bypass line. At 308, the solenoid can remain closed for a second set period of time (closed time).

### Computer-Implemented System

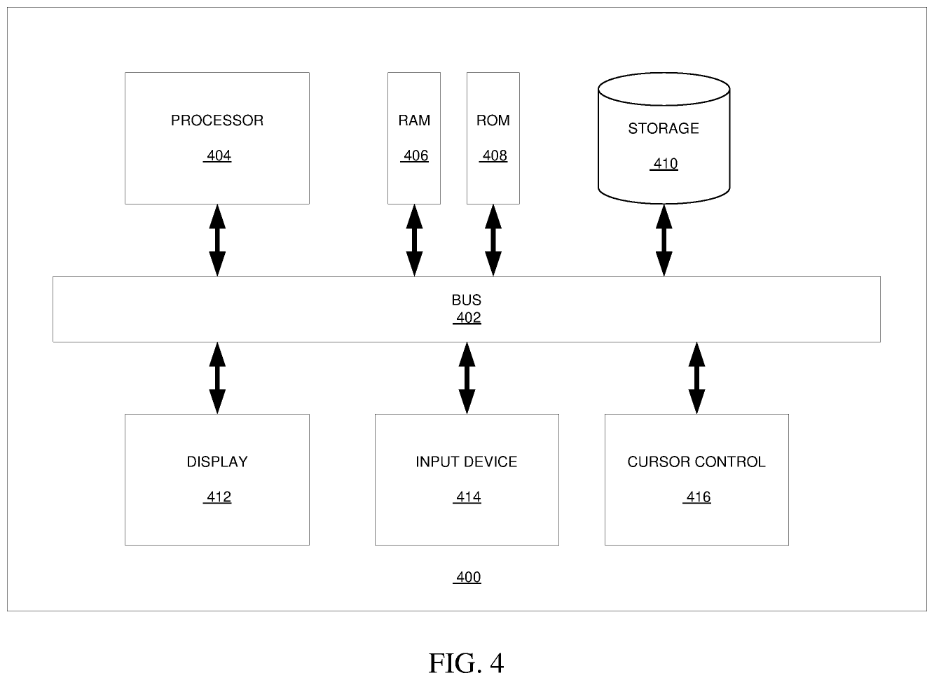

FIG. 4 is a block diagram that illustrates a computer system 400, upon which embodiments of the present teachings may be implemented as which may incorporate or communicate with a system controller, for example controller 108 shown in FIG. 1, such that the operation of components of the associated mass spectrometer may be adjusted in accordance with calculations or determinations made by computer system 400. In various embodiments, computer system 400 can include a bus 402 or other communication mechanism for communicating information, and a processor 404 coupled with bus 402 for processing information. In various embodiments, computer system 400 can also include a memory 406, which can be a random access memory (RAM) or other dynamic storage device, coupled to bus 402, and instructions to be executed by processor 404. Memory 406 also can be used for storing temporary variables or other intermediate information during execution of instructions to be executed by processor 404. In various embodiments, computer system 400 can further include a read only memory (ROM) 408 or other static storage device coupled to bus 402 for storing static information and instructions for processor 404. A storage device 410, such as a magnetic disk or optical disk, can be provided and coupled to bus 402 for storing information and instructions.

In various embodiments, computer system 400 can be coupled via bus 402 to a display 412, such as a cathode ray tube (CRT) or liquid crystal display (LCD), for displaying information to a computer user. An input device 414, including alphanumeric and other keys, can be coupled to bus 402 for communicating information and command selections to processor 404. Another type of user input device is a cursor control 416, such as a mouse, a trackball or cursor direction keys for communicating direction information and command selections to processor 404 and for controlling cursor movement on display 412. This input device typically has two degrees of freedom in two axes, a first axis (i.e., x) and a second axis (i.e., y), that allows the device to specify positions in a plane.

A computer system 400 can perform the present teachings. Consistent with certain implementations of the present teachings, results can be provided by computer system 400 in response to processor 404 executing one or more sequences of one or more instructions contained in memory 406. Such instructions can be read into memory 406 from another computer-readable medium, such as storage device 410. Execution of the sequences of instructions contained in memory 406 can cause processor 404 to perform the processes described herein. In various embodiments, instructions in the memory can sequence the use of various combinations of logic gates available within the processor to perform the processes describe herein. Alternatively hard-wired circuitry can be used in place of or in combination with software instructions to implement the present teachings. In various embodiments, the hard-wired circuitry can include the necessary logic gates, operated in the necessary sequence to perform the processes described herein. Thus implementations of the present teachings are not limited to any specific combination of hardware circuitry and software.

The term “computer-readable medium” as used herein refers to any media that participates in providing instructions to processor 404 for execution. Such a medium can take many forms, including but not limited to, non-volatile media, volatile media, and transmission media. Examples of non-volatile media can include, but are not limited to, optical or magnetic disks, such as storage device 410. Examples of volatile media can include, but are not limited to, dynamic memory, such as memory 406. Examples of transmission media can include, but are not limited to, coaxial cables, copper wire, and fiber optics, including the wires that comprise bus 402.

Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

In various embodiments, the methods of the present teachings may be implemented in a software program and applications written in conventional programming languages such as C, C++, etc.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

The embodiments described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The embodiments, described herein, also relate to a device or an apparatus for performing these operations. The systems and methods described herein can be specially constructed for the required purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

What is claimed is:

1. A system comprising:
a gas source coupled to a mass spectrometer with a supply line to provide reagent gas for chemical ionization;
a bypass line connecting the supply line to a foreline of a vacuum pump, the bypass line including a valve and a bypass restrictor; and
a cycle timer operable to open the valve for a first period of time and close the valve for a second period of time.

2. The system of claim 1, comprising a reagent gas controller, the reagent gas controller configured to control a flow of reagent gas into an ion source of a mass spectrometer.

3. The system of claim 2, wherein the reagent gas controller is configured to provide the reagent gas flow to the ion source during chemical ionization.

4. The system of claim 2, wherein the reagent gas controller is configured to shut off the reagent gas flow into the ion source during electron ionization.

5. The system of claim 1, wherein the valve is a solenoid valve.

6. The system of claim 1, wherein the first period of time is a function of a flow rate through the bypass line, a length of the supply line, the inner diameter of the supply line, or any combination thereof.

7. The system of claim 1, comprising a controller, the controller configured to adjust the cycle timer.

8. The system of claim 7, wherein the controller configured to instruct the cycle timer to open the valve to flush the supply line prior to chemical ionization analysis.

9. The system of claim 7, wherein the controller configured to instruct the cycle timer to keep the valve closed when the mass spectrometer is collecting chemical ionization data.

10. A method of periodically purging a supply line for providing reagent gas to a mass spectrometer for chemical ionization, comprising:
open a valve to provide a gas flow through a bypass line connecting the supply line to a vacuum pump;
keep the valve open for a first period of time to purge the supply line;
close the valve to shut off the gas flow through the bypass line;
keep the valve closed for a second period of time.

11. The method of claim 10, providing a flow of reagent gas through the supply line to an ionization volume of a mass spectrometer during chemical ionization.

12. The method of claim 11, preventing the flow of reagent to the ionization volume when not performing chemical ionization.

13. The method of claim 10, wherein the valve is a solenoid valve.

14. The method of claim 10, wherein the first period of time is a function of a flow rate through the bypass line, a length of the supply line, the inner diameter of the supply line, or any combination thereof.

15. The method of claim 10, opening the valve to purge the supply line prior to chemical ionization analysis.
The system of claim 7, keeping the valve closed when the mass spectrometer is collecting chemical ionization data.
